(19) United States
(12) Patent Application Publication
(10) Pub. No.: US 2006/0017231 A1
(43) Pub. Date: Jan. 26, 2006

(54) Cylinder head gasket with data transmitter

(76) Inventors: Gerhard Rohner, Hemsbach (DE); Hans-Jurgen Diekmann, Birkenau (DE); Sven Flosser, Weinheim (DE); Jean-Louis Teytaud, Vaulry (FR)

Correspondence Address: HARNESS, DICKEY & PIERCE, P.L.C., P.O. BOX 828, BLOOMFIELD HILLS, MI, 48303, US

(21) Appl. No.: 11/153,229

(22) Filed: Jun. 15, 2005

(30) Foreign Application Priority Data
Jun. 18, 2004 (DE) 102004029575.1

(51) Int. Cl. G01L 23/22; F16J 9/00; F02F 11/00

(52) U.S. Cl. 277/317; 277/591; 73/35.13

(57) ABSTRACT

A cylinder head gasket with a distance-measuring device for the pressure in cylinders of internal combustion engines is described. Measurement of the cylinder pressure is provided by an inductive distance-measuring device in a recess of the cylinder head gasket. The device after the installation of the cylinder head gasket is disposed between mutually facing surface regions of the engine block and the cylinder head and is capable of generating a signal for the distance between the engine block and the cylinder head which varies as a function of the pressure prevailing in the cylinder during operation of the internal combustion engine.

### CROSS-REFERENCE TO RELATED APPLICATIONS

This application claims the benefit of German patent application 10 2004 029575.1, filed Jun. 18, 2004. The disclosure of the above application is incorporated herein by reference in its entirety.

### FIELD OF THE INVENTION

The invention relates to a cylinder head gasket for disposal between an engine block and a cylinder head of an internal combustion engine.

### BACKGROUND OF THE INVENTION

The control and regulation of internal combustion engines requires that a multiplicity of measurement data be acquired and electronically evaluated. In the development of modern internal combustion engines, efforts are made to reduce fuel consumption and the emission of noxious gases, to improve efficiency, and to extend the useful life of the engine. These and other, sometimes opposite, goals fall under “the optimization of motor management”.

An important parameter is the pressure or pressure variation in the individual cylinders of the internal combustion engine. In gasoline engines, the recognition and regulation of knock are important as is the recognition of misfiring. In diesel engines, the important aspect is the measurement of peak pressures and a highly accurate acquisition of cylinder pressure development.

A direct measurement of pressure with the aid of sensors disposed in the combustion space is in most cases not possible because of space-related reasons and the attendant high cost. Although the disposition of pressure sensors in spark plugs and glow plugs is less expensive and has already been proposed, it has not yet been accepted for serial production. Moreover, attempts have already been made to dispose sensors in the cylinder head gasket that are capable of directly measuring the cylinder pressure. This, however, can be accomplished only by providing a thicker cylinder head gasket and, because of the cylinder volume modification, by changing the engine design. In addition, sealing and durability problems can arise.

Hence, it has already been proposed to measure the cylinder pressure indirectly. As is known, the engine block and the cylinder head are fastened to each other by means of screws that are so tightly fastened that even at the highest prevailing cylinder pressure, no leaking can take place. Compared to a resting situation where the internal combustion engine is turned off, the cylinder pressure in a running internal combustion engine subjects the screws to an additional expansion force which, however, is partly relieved by the initial stressing force exerted by the screws on pressure-stressed regions of the engine block and cylinder head. These effects can be utilized for an indirect pressure measurement by either detecting the additional extension of the screws by means of strain gauges, or by determining the reduction in pressure forces by means of piezo-sensors disposed in the force flux between the engine block and the cylinder head. Both approaches were found to be too expensive and apt to cause trouble.

The objects of the invention are to overcome the aforedescribed drawbacks and difficulties in measuring the cylinder pressure in internal combustion engines, and to provide, for the optimization of motor management, a pressure measurement method that is simple, inexpensive, and suitable for large-scale serial production, and that can be used in trouble-free manner and for a long time.

### SUMMARY OF THE INVENTION

According to the invention, a cylinder head gasket is provided that includes an inductive distance-measuring device that produces a signal that represents the distance between surface regions of the engine block and cylinder head that face each other. By such a cylinder head gasket, the distance, which changes during operation depending on the cylinder pressure of the internal combustion engine, can be measured.

The invention is based on the fact that not only do the force relationships in the cylinder head screws and in the pressure-stressed regions of the engine block and the cylinder head change, but also that the distance between the engine block and the cylinder gasket increases as a function of the cylinder pressure. With the aid of inductive distance-measuring devices, this change in distance can be measured instead of the cylinder pressure.

Because the distance variations between engine block and cylinder head are not the same over the entire sealing surface between these two vehicle components, the inductive distance-measuring device in the cylinder head gasket is preferably disposed at the greatest possible distance from the through-holes for the cylinder head screws where the greatest distance variation can be expected. Compared to the engine block, the cylinder head is a substantially less rigid structure, the mechanical strength of which varies depending on its design. First of all, the greatest distance variations can be expected in regions that are located furthest away from the sites where the cylinder head screws are disposed. Moreover, the function-dependent geometry of the cylinder head exerts an effect so that additionally it may be advantageous, from the standpoint of an increase in the distance variation to be measured, to design the cylinder head to be mechanically “softer,” naturally without impairing the other functions, and without the risk of causing leaks.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a basic circuit of an inductive distance-measuring device according to a principle of the present invention;

FIG. 2 shows the arrangement of an inductive distance-measuring device in a cylinder head gasket for a 4-cylinder engine according to a principle of the present invention;

FIG. 3 shows another configuration of the inductive distance-measuring device in a cylinder head gasket according to FIG. 2;

FIG. 4 shows a first example of an arrangement of an inductive distance-measuring device in cross-section according to a principle of the present invention;

FIG. 5 shows a second example of an arrangement of an inductive distance-measuring device according to a principle of the present invention; and

FIG. 6 shows a third example of an arrangement of an inductive distance-measuring device according to a principle of the present invention.

### DETAILED DESCRIPTION OF THE PREFERRED EMBODIMENTS

The following description of the preferred embodiment(s) is merely exemplary in nature and is in no way intended to limit the invention, its application, or uses.

In the basic oscillation circuit of FIG. 1, reference numeral 1 indicates a voltage source, reference numeral 2 denotes a switching circuit of inductivity L and capacity C, reference numeral 3 denotes signal preprocessing unit, and 4 denotes a device for signal indication. The basic design of the oscillator circuit makes it is possible, by means of an inductive distance-measuring device, to convert the distance variation between an engine block and a cylinder head into an electric signal suitable for motor management.

Circuit operation is based on the principle of loosely coupled air-core coils. When a short-circuited coil is brought into the vicinity of the sensor coil, the latter withdraws energy which results in a variation of amplitude and frequency. In use, the short-circuited coil is replaced by one or two metallic surfaces. In these surfaces, eddy current losses take place. The surfaces are formed either by the cylinder head or by the engine block, or by both. They can also be formed by layers of the cylinder head gasket itself.

The pressure changes in the cylinder result in a sealing gap variation, namely in changes in distance between the engine block and the cylinder head, and in the oscillator circuit they produce frequency and amplitude variations that can be evaluated as a measure of the sealing gap change and thus as a measure of the cylinder pressure. The sensor system is characterized by good correlation between the initial signal and the internal cylinder pressure and good durability, because the distance-measuring device consists merely of a simple coil. Other active or passive sensors have a more complicated structure and, hence, are substantially more sensitive to temperature changes and mechanical influences than are the coils used as the inductive distance-measuring device which, in addition, are structurally substantially more stable than, for example, the piezo-sensors used for pressure measurement.

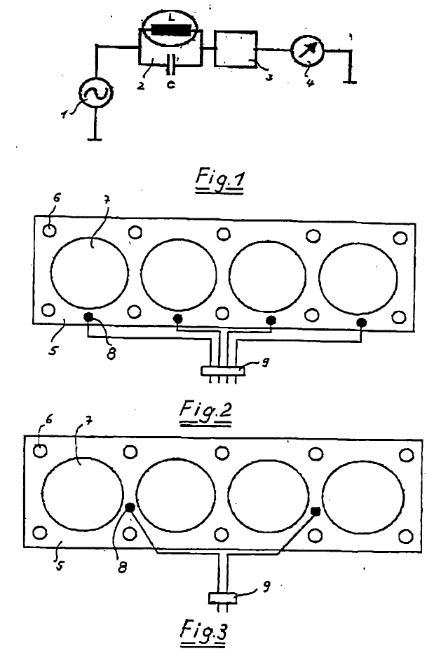

The cylinder head gasket 5 shown in top view in FIG. 2 is provided with recesses 6 for the cylinder head screws, and with recesses 7 for the cylinders. Inductive distance-measuring devices 8 are disposed at the greatest possible distance from the recess 6 for the cylinder head screws. Their connecting lines are brought together in a plug 9 in which means for electronic signal preprocessing can also be disposed.

FIG. 3 differs from FIG. 2 only in that instead of four inductive distance-measuring devices 8, there are provided only two inductive distance-measuring devices 8. The two inductive distance-measuring devices are each “responsible” for two adjacent cylinders, wherein the pressure signals are assigned to one of the two cylinders electronically in a different manner, for example via the work cycle sequence or the ignition sequence.

FIGS. 4 to 6 show possible configurations of the inductive distance-measuring devices 8 in cross-section. In each case, a recess is provided in the cylinder head gasket 5 disposed between engine block 10 and the cylinder head wherein the inductive distance-measuring device 8 is located and fixed between a first layer 12 made of rigid material and a second layer 13 made of a spring material. To maximize utilization of the distance variations occurring between the engine block and the cylinder head during operation, the materials constituting layers 12 and 13 are to be selected so that the distance variation of the inductive distance-measuring device 8 relative to one of the two reference surfaces—preferably the surface of engine block 10—is zero or as small as possible. Relative to the other reference surface of cylinder head 11, the distance variation is as large as possible.

On the other hand, however, it must be ensured that the inductive distance-measuring devices 8 in the recess of cylinder head gasket 5 are fixed so that external influences that could cause erroneous measurements can be reduced as much as possible. A special advantage of the inductive distance-measuring devices integrated into the cylinder head gasket lies in that the devices are not located in the force flux, and that only their position between the reference surfaces of the engine block and cylinder head must be fixed.

FIG. 4 shows a single-layer cylinder head gasket 5 with the inductive distance-measuring device 8 disposed in a recess of the cylinder head gasket that encloses the entire layer thickness of the cylinder head gasket. In other words, it extends vertically from the reference surface of engine block 10 to the reference surface of cylinder head 11.

FIG. 5 shows a two-layer cylinder head gasket 5, the upper layer 5a of which has no recess so that the recess extends vertically only from the lower reference surface of engine block 10 to the underside of the continuous layer 5a of the cylinder head gasket.

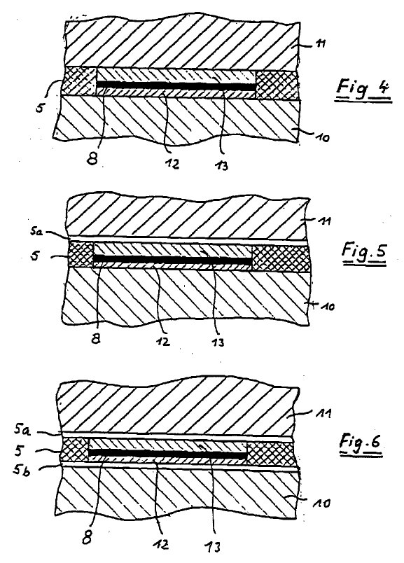

FIG. 6 shows a cylinder head gasket with a three-layer structure wherein the upper layer 5a and the lower layer 5b are configured continuously. In this case, the reference surfaces are formed by the internally disposed surface layers 5a and 5b.

Other variants of the above embodiments are obtained by interchanging layers 12 and 13 in FIG. 4, by providing in FIG. 5 a recess in cylinder head gasket 5 which also encloses upper layer 5a and that in FIG. 6 the recess in the cylinder head gasket extends over one or both of the outer layers 5a and 5b.

The description of the invention is merely exemplary in nature and, thus, variations that do not depart from the gist of the invention are intended to be within the scope of the invention. Such variations are not to be regarded as a departure from the spirit and scope of the invention.

1. A cylinder head gasket for disposal between an engine block and a cylinder head of an internal combustion engine that includes a plurality of cylinders, the cylinder head gasket comprising an inductive distance-measuring device that generates a signal that represents a distance that chances during operation of the internal combustion engine, said distance being between a surface region of the engine block and a surface region of the cylinder head that face each other, wherein said distance changes due to a function of the cylinder pressure of the internal combustion engine.

2. The cylinder head gasket as defined in claim 1, wherein said inductive distance-measuring device is connected to an oscillator circuit and is disposed at a greatest possible distance from a plurality of pass-through holes formed for a plurality of cylinder head screws in the cylinder head gasket.

3. The cylinder head gasket as defined in claim 1, wherein each cylinder of the internal combustion engine includes an inductive distance-measuring device.

4. The cylinder head gasket as defined in claim 1, wherein for each two adjacent cylinders of the plurality of cylinders there is provided only one inductive distance-measuring device; and
the signal is assigned to one or another of the two cylinders by means of an acquired work cycle sequence of the internal combustion engine.

5. The cylinder head gasket as defined in claim 1, wherein the inductive distance-measuring device is structurally integrated into the cylinder head gasket.

6. The cylinder head gasket as defined in claim 5, wherein the inductive distance-measuring device is configured as a single-layer or multilayer flat coil.

7. The cylinder head gasket as defined in claim 5, wherein the inductive distance-measuring device is fixed in a recess of the cylinder head gasket by a spring material or a spacing material.

8. The cylinder head gasket as defined in claim 7, wherein layers of the spring and spacing materials are used to fix the inductive distance-measuring device in the recess of the cylinder head gasket.

9. The cylinder head gasket as defined in claim 1, further comprising a plurality of additional sensors for offset compensation and/or variation compensation, the additional sensors being integrated into the cylinder head gasket.

10. The cylinder head gasket as defined in claim 1, wherein the inductive distance-measuring device also measures temperature.

11. The cylinder head gasket as defined in claim 1, further comprising a connection plug for the inductive distance-measuring device, the connection plug being provided with an electronic circuit for sensor signal preprocessing.

12. The cylinder head gasket according to claim 6, wherein the single-layer or multilayer flat coil is wound, pressed, or etched into a flexible or rigid printed wiring board.

13. The cylinder head gasket according to claim 6, wherein the single-layer or multilayer flat coil is cut into sheet metal.

14. The cylinder head gasket according to claim 8, wherein the inductive distance-measuring device is fixed in the recess of the cylinder head gasket on one side by an inelastic spacing material and on another side by a spring material.
